(19) United States
(12) Patent Application Publication
(10) Pub. No.: US 2026/0318368 A1
(43) Pub. Date: Oct. 15, 2026

(54) APPARATUS HAVING A MAGNETORHEOLOGICAL TRANSMISSION DEVICE AND A SENSOR DEVICE

(71) Applicant: INVENTUS ENGINEERING GMBH, St. Anton i.M. (AT)

(72) Inventor: Stefan Battlogg, St. Anton i.M. (AT)

(21) Appl. No.: 19/483,325

(22) PCT Filed: May 7, 2024
(86) PCT No.: PCT/EP2024/062628

§ 371 Date: Nov. 11, 2025

(30) Foreign Application Priority Data
May 11, 2023 (DE) 10 2023 112 526.5

(51) Int. Cl. F16D 37/02; F16D 37/00

(52) U.S. Cl. CPC F16D 37/02; F16D 2037/001; F16D 2037/007; F16D 2300/18

(57) ABSTRACT

A device having a magnetorheological transmission device with two rotary components that are movable relative to one another. A gap is formed between the rotary components and the gap is filled with a magnetorheological medium. A coil is used to generate a controllable magnetic field in the gap. A sensor senses position information and has two sensor units comprising an active exciter-receiver unit and a passive target unit. One sensor unit is arranged on one rotary component and the other sensor unit is arranged on the other rotary component. The gap extends at least partially between the sensor units.

The invention relates to a device with at least one magnetorheological transmission device with at least two rotary components movable relative to one another and with at least one sensor device for detecting position information.

Such devices can be used in a variety of ways, for example as a steering control device for inputting a steering movement according to the steer-by-wire concept or as a haptic control button. As a rule, the device should be able to transmit high torques and at the same time have as low a base torque as possible. In addition, it is often required that the device is structurally simple and requires little installation space. The connection to supply and control lines should also be as simple and reliable as possible.

Sensors for detecting position information and, for example, the angle of rotation of the rotating components play an important role in the targeted and rapid control of such devices. However, their structural accommodation often presents considerable difficulties, as the available installation space is usually very small. In addition, the magnetic field of the electrical coil device for influencing the magnetorheological medium regularly has a disruptive effect on sensors that also generate or detect a magnetic field.

It is therefore the object of the present invention to provide an improved device which particularly advantageously meets the previously discussed requirements and provides a reliable and inexpensive sensor system for detecting position information.

This object is achieved by a device having the features of claim 1. Preferred developments of the invention are the subject of the subclaims. Further advantages and features of the present invention emerge from the general description and from the description of the embodiments.

The device according to the invention comprises at least one magnetorheological transmission device. The transmission device comprises at least two rotary components that can be moved (rotated) relative to one another. At least one circumferential gap is formed between the rotary components. A magnetorheological medium is arranged in the gap, at least in sections. The device comprises at least one electrical coil device for generating a controllable magnetic field in the gap. In particular, the magnetic field serves to influence the medium in order to adjust the rotational resistance of the rotary components. The device comprises at least one sensor device for detecting (rotational) position information of at least one of the rotary components. The sensor device has at least two sensor units, comprising an active exciter-receiver unit and a passive target unit. One sensor unit (in particular the exciter-receiver unit) is arranged and in particular fastened to one rotary component and the other sensor unit (in particular the target unit) is arranged and in particular fastened to the other rotary component. The gap runs at least in sections between the sensor units. In particular, the electrical and/or magnetic fields emanating from the sensor units must pass through the gap.

The device according to the invention offers many advantages. A significant advantage is the special arrangement of the sensor units in relation to the rotating components of the transmission device so that the gap runs between the sensor units. This enables a particularly compact and at the same time structurally uncomplicated integration of the sensor device into the transmission device. Overall, the previously discussed requirements can be implemented particularly advantageously with the invention.

Preferably, at least one of the sensor units is arranged at least partially in the gap. At least one of the sensor units can at least partially protrude into the gap. At least one of the sensor units can delimit the gap at least in sections in the manner of a wall. In particular, such embodiments are provided for both sensor units.

It is preferred and advantageous that the magnetorheological medium is arranged at least in sections between the sensor units. In particular, electrical and/or magnetic fields emanating from the sensor units (which are transmitted for the purpose of detecting position information) must pass through the medium. The applicant reserves the right to claim a device according to the preamble of claim 1, which is characterized in that the magnetorheological medium is arranged at least in sections between the sensor units. This enables a particularly advantageous integration of the sensor device into the transmission device. Surprisingly, it has been shown that the magnetorheological medium does not adversely affect the induction of eddy currents or fields between the sensor units.

It is also preferred and advantageous that at least one of the sensor units is surrounded by the medium (in contact) at least in part. It is also possible that both sensor units are surrounded by the medium (in contact) at least in part. In particular, the medium at least touches the target unit. Surprisingly, the Contact with the magnetorheological medium does not adversely affect the signal transmission (of the magnetic fields) between the sensor units.

In particular, the gap is not divided into two gap zones by a seal or the like, so that the medium would be in one gap zone and the other gap zone would run between the sensor units. In particular, the medium is not shielded from the sensor units by a seal arranged in the gap. This enables a particularly low base torque. This is because such a seal would undesirably increase the base torque. The direct contact of the at least one sensor unit with the medium or the omission of the seal therefore enables the rotating components to rotate particularly easily. It is fundamentally possible and advantageous in certain embodiments to provide a seal which keeps the medium out of the gap between the sensor units. A contactless and, for example, magnetic seal can be provided.

In particular, at least one of the sensor units is connected in a rotationally fixed manner to the rotary component on which the respective sensor unit is arranged. In particular, both sensor units are each connected in a rotationally fixed manner to their associated rotary component. In particular, the sensor units are mounted so that they can rotate relative to one another. In particular, the mounting takes place in that they are each fastened to one of the rotary components.

The sensor units are preferably each arranged on an axial end face of their associated rotary component. In particular, the sensor units are arranged on facing end faces. In particular, the gap runs at least in sections between the axial end faces of the rotary components.

In particular, at least one of the sensor units is connected to a such a component structure of its associated rotary component which directly delimits the gap. In particular, both sensor units are arranged in such a way. For example, such component structures are the core described below and/or the cover unit described below.

It is preferred and advantageous that at least one of the sensor units is arranged on such a component structure of its associated rotary component, which is magnetically and/or electrically conductive. In particular, it is a component structure through which the controllable magnetic field of the coil device flows when the medium is specifically influenced by the coil device. For example, such a component structure is a core and/or a ring unit or the like.

In an advantageous development, at least one of the sensor units is at least partially connected in one piece with its associated rotary component. The applicant reserves the right to claim a device according to the preamble of claim 1, which is characterized in that at least one of the sensor units is at least partially connected in one piece with its associated rotary component. In particular, the target unit is at least partially (preferably its rotor geometry) connected in one piece with the rotary component and preferably its core and/or cover unit.

In particular, the rotary components are arranged coaxially to one another at least in sections. In particular, one rotary component is arranged radially inward and one rotary component radially outward. In particular, the gap runs circumferentially between the inner and outer rotary components. In particular, the gap also runs on at least one axial end face between the rotary components. In particular, the radially outer rotary component extends at least in sections around the radially inner rotary component. In particular, a core of the radially inner rotary component is completely enclosed by the radially outer rotary component. In particular, one rotary component is stationary. In particular, the other rotary component is rotatably mounted (on the stationary rotary component) so that it can be rotated relative to the stationary rotary component. In particular, the supply lines and/or control lines run through the stationary rotary component.

It is possible and advantageous for the sensor device to comprise at least one correction device or to be operatively connected to such a device. The correction device is particularly suitable and designed to carry out a compensation process using at least one algorithm and preferably to at least partially (automatically) compensate for an off-axis deviation and/or a tilt-deviation.

Possible manufacturing and/or assembly inaccuracies that could result in the exciter-receiver unit and the target unit and/or the rotary components not being arranged coaxially, i.e. eccentrically (so-called off-axis deviation), to one another, can be taken into account by adapting the measurement signals recorded by the sensor device, e.g. a current curve and/or voltage curve, as part of a compensation process. Such compensation processes or offset compensation processes are well known as such. For example, the sensor device can automatically compensate for this deviation. Such sensor devices are available on the market. On the other hand, compensation of the measured values in an evaluation logic that is independent of the sensor device is also conceivable and possible. Other deviations, such as an inclination of the exciter-receiver unit to the target unit (so-called tilt deviation), can also be compensated by compensation methods.

In particular, the radially outer rotary component has at least one cover unit. In particular, the cover unit covers the radially inner rotary component and in particular its core axially at the front. Preferably, the cover unit also closes the gap axially at the front. The cover unit can have at least one (central) through-bore through which the other (inner) rotary component extends.

In an advantageous embodiment, one of the sensor units is at least partially arranged on the cover unit and preferably fastened thereto. This offers a structurally uncomplicated and particularly space-saving accommodation of the sensor unit. The cover unit is made in particular of a magnetically and/or electrically non-conductive material. However, the cover unit can also be magnetically and/or electrically conductive. In this case, a shielding component and/or at least one separation joint is preferably arranged between the cover unit and the target unit.

The radially outer rotary component has, in particular, a ring unit. In particular, the ring unit covers the radially inner rotary component. In particular, the ring unit provides at least one cylindrical receiving space for the radially inner rotary component. In particular, the receiving space is closed axially at the front by the cover unit. In particular, the ring unit is designed to be magnetically and/or electrically conductive. In particular, the cover unit is attached to the ring unit. It is possible for the cover unit and the ring unit to be connected to one another in one piece. In particular, the controllable magnetic field of the coil device flows through the ring unit when the medium is specifically influenced with the coil device.

It is possible and advantageous for the radially inner rotary component to have a magnetically and/or electrically conductive core. In a particularly advantageous development, one of the sensor units is arranged on the core. In particular, the controllable magnetic field of the coil device flows through the core when the medium is specifically influenced by the coil device. In particular, the gap runs circumferentially around the core and on at least one axial end face along the core. In particular, the sensor unit is arranged on an axial end face of the core. In particular, the end face faces the gap and/or a cover unit of the other rotating component.

The magnetically conductive component structures of the rotating components and in particular the core and/or the ring unit can be equipped with a contour that projects into the gap. The contour preferably results in a gap height that is variable in the circumferential direction. The contour can, for example, be designed as a star contour or the like.

The target unit preferably has at least one (relief-like) rotor geometry or is designed as such. In particular, the rotor geometry encodes relative and/or absolute position information. The coding is carried out, in particular, by defined distributed zones with different induction effects on the exciter-receiver unit and/or with different conductivity. In particular, the zones are distributed in the circumferential direction of the rotor geometry.

For example, zones that are arranged closer to the exciter-receiver unit and/or that are more conductive can alternate with zones that are further away from the exciter-receiver unit and/or that are less conductive. The zones are, in particular, part of a relief structure. The zones can be designed or distributed symmetrically and/or asymmetrically. An asymmetry is used, in particular, for the detection of absolute position information.

For example, the rotor geometry is designed in a wing-like and/or star-shaped manner. In particular, the rotor geometry is arranged coaxially to the axis of rotation of the sensor units or rotating components. In particular, the rotor geometry is designed to be magnetic and/or electrically conductive. In particular, the rotor geometry is made of a metallic material.

The rotor geometry is preferably arranged in the gap. The rotor geometry is preferably completely covered by the medium. Information with reference to the magnetorheological medium refers, in particular, to a transmission device that is filled as intended and ready for operation. In particular, the rotor geometry faces the gap and/or the exciter-receiver unit.

The rotor geometry preferably has at least one relief structure. The relief structure comprises in particular elevations and depressions. The elevations and depressions are arranged in a defined distribution in particular in the circumferential direction or in the intended direction of rotation. It is preferred and advantageous that the depressions are filled with the medium or with air. In particular, the relief structure is at least partially filled with the medium. In particular, at least one elevation and/or depression differs from the other elevations or depressions, so that at least one absolute position information can be encoded.

In a preferred and advantageous embodiment, the rotor geometry is at least partially connected in one piece with the core or the cover unit. In particular, the rotor geometry is incorporated into the core or the cover unit. In particular, the rotor geometry is formed in fine pieces with the core or the cover unit. In particular, the rotor geometry represents an integral component of the core or the cover unit. For example, the rotor geometry is formed on an axial end face of the core. Preferably, the one-piece connection comprises at least the relief structure of the rotor geometry.

In particular, the rotor geometry is produced by removing material from one of the rotating components and preferably from the core or the cover unit. The rotor geometry can also be produced by material deposition, for example by an additive manufacturing process. The rotor geometry can also be formed together with its associated rotating component, for example by a casting process.

It is possible and advantageous that the rotor geometry has at least one separation joint to counteract a propagation of the induced eddy currents into the core.

In particular, the at least one separation joint is arranged on an axial side of the rotor geometry facing the core. In particular, the separation joint is designed to be circumferential. In particular, the separation joint can also be referred to as an annular groove or undercut. The separation joint is preferably at least partially filled with the medium. However, the separation joint can also be filled with air or a shielding medium. In particular, the separation joint is connected to the gap or is part of the gap. The separation joint is preferred when the rotor geometry is designed in one piece with the core or another conductive component structure. However, the separation joint can also be provided when the rotor geometry is attached as a separate component.

In particular, the separation joint is wider than the part of the rotor geometry which is separated by the separation joint. At least two or a plurality of separation joints can also be provided. For example, the individual elevations can be at least partially equipped with a separation joint. It is possible for the elevations to be narrower on their axial side facing the core than on their axial side facing the exciter-receiver unit.

In an advantageous embodiment, it is provided that the target unit (as a separate component) is attached to the cover unit or to the core. Preferably, a magnetic and/or electrically non-conductive shielding component is arranged between the rotor geometry and the core or between the rotor geometry and the cover unit. This enables a simple and reliable assembly of the rotor geometry and at the same time prevents uncontrolled spread of the induced eddy currents. For example, the shielding component is designed as a disk made of a non-conductive material.

If the rotor geometry is arranged on the cover unit, it is preferably arranged on an inner side of the cover unit facing the gap. It is also possible for the rotor geometry to be arranged on an outer side of the cover unit facing away from the gap. The cover unit is then particularly permeable to the fields that are transmitted between the sensor units.

It is preferred and advantageous that the exciter-receiver unit is arranged on the rotary component on which the electrical coil device is also arranged. This enables a common cable routing. In particular, the exciter-receiver unit and/or the electrical coil device is arranged on the fixed rotary component. In particular, the target unit is arranged on the rotary component on which the electrical coil device is not arranged. In particular, the target unit is arranged on the rotatable rotary component.

In particular, the exciter-receiver unit has at least one exciter coil (primary coil) and at least one receiver coil (secondary coil). In particular, the exciter coil is designed to induce eddy currents in the target unit. In particular, a magnetic and/or electric field can be induced in the receiver coil by means of the eddy currents induced in the target unit. In particular, this field depends on a rotational position (angular position) of the target unit (relative to the exciter-receiver unit). In particular, the field induced in the receiver coil provides position information about the absolute or relative position of the target unit and the rotational component coupled to it to the exciter-receiver unit.

The excitation coil and the receiver coil are preferably at least partially located in a common plane. In particular, the excitation coil and the receiver coil are arranged on a common circuit board, for example a circuit board. In particular, the excitation coil and the receiver coil are connected in a rotationally fixed manner. In particular, the excitation coil and the receiver coil are arranged coaxially.

It is possible that the exciter-receiver unit is partially connected in one piece with its rotating component. For example, at least one coil carrier for the exciter coil and/or the receiver coil is incorporated into the rotating component.

In all embodiments, it is particularly preferred and advantageous that the magnetorheological medium is designed as a powder. In particular, the powder is absorbed in a gas and preferably in air.

In particular, the magnetorheological medium comprises magnetically responsive (magnetizable) particles and gas as a filling medium. In particular, the magnetically responsive particles are absorbed in air. In particular, the magnetorheological medium is designed as a powder. With such a magnetorheological medium, the invention presented here enables a particularly low fundamental moment. Alternatively, it is conceivable and possible for the magnetorheological medium to comprise magnetizable particles and a carrier liquid, such as oil, water or alcohol.

It is particularly preferred that the magnetizable particles (each) consist predominantly of carbonyl iron powder or derivatives thereof. Other magnetically responsive particles are also possible. The magnetizable particles can have coatings to protect against abrasion and/or corrosion and/or additional components to make the magnetically responsive particles more durable, abrasion-resistant and/or slippery during operation. The magnetorheological medium can, for example, include a graphite additive.

In particular, one rotary component (in particular the inner rotary component) penetrates the other rotary component (in particular the outer rotary component) on one axial side. It is possible for one (inner) rotary component to penetrate the other (outer) rotary component on both opposite axial sides. In other words, one (inner) rotary component protrudes on one side or both sides in the axial direction over the other (outer) rotary component. As a result, the transmission device can be integrated in the axial direction between two components and serve, for example, as a clutch. The components can be, for example, a steering control device and a motor. The device can comprise such components.

In particular, at least one shaft seal, e.g. at least one O-ring, is arranged between the rotating components in the region of the at least one penetration. The shaft seal serves in particular to seal the effective gap in order to prevent the magnetorheological medium from escaping.

It is possible for the sensor device to be arranged on the axial side on which the at least one penetration is arranged. In particular, at least one sensor unit is then also penetrated by the rotary component. In particular, the sensor unit arranged on the rotary component penetrated by the other rotary component is also penetrated by the rotary component. In an advantageous embodiment, the sensor unit is then equipped with a (central) through-bore. In particular, the sensor unit is circular in shape. In particular, the at least one shaft seal is arranged between the penetrated sensor unit and the other sensor unit. The sensor device can also be arranged on the axial side on which no penetration is arranged.

One rotary component (in particular the inner rotary component) can comprise a shaft. In particular, the other rotary component (in particular the outer rotary component) is mounted on the shaft so that relative rotation is provided. The shaft can have at least one (central) supply channel in which supply lines for energy and/or signal transmission can be arranged. The supply channel can be designed, for example, as a bore (tap bore or through bore). The shaft can be designed as a hollow shaft.

In particular, the exciter-receiver unit induces eddy currents in the target unit. In particular, the eddy currents in turn induce a magnetic and/or electric field in the exciter-receiver unit. In particular, the field induced in the exciter-receiver unit depends on a position of the target unit relative to the exciter-receiver unit. In particular, the field induced in the exciter-receiver unit provides absolute and/or relative position information about the position of the target unit. Since the target unit is preferably arranged on one of the rotary components (non-rotatably), position information for at least one of the rotary components can thus also be determined. The sensor device is in particular an inductive rotary encoder. In particular, the sensor device is not a Hall sensor.

The position information can be relative or absolute. The position information can describe the position of one rotational component relative to the other rotational component. The position information can also describe the absolute position of at least one rotational component. It is also possible for the position information to describe a direction of rotation and/or speed and/or acceleration and/or other movement information. Where the gap runs between the sensor units, it extends (with respect to its main plane), in particular, transversely to the axis of rotation of the rotating components and/or transversely to the axis of rotation of the sensor units (or in the radial direction).

The sensor units are, in particular, arranged adjacent to (but spaced apart from) one another. In particular, the distance is at least the width of the gap between the sensor units. In particular, a distance between the sensor units is not more than ten times and preferably not more than five times the width of the gap which extends between the sensor units. In particular, the sensor units are spaced apart from one another at least by the gap and also by the medium and optionally by at least one shielding component.

In particular, the sensor units are arranged axially one behind the other. In particular, the axes of rotation of the rotary components and the sensor units are identical. In particular, the sensor units and the rotary components are arranged coaxially to one another. In particular, the sensor units are located at least in sections radially within the outer rotary component. In particular, the rotor geometry is arranged radially within the outer rotary component. In particular, the outer rotary component also encloses at least one of the sensor units in the axial direction.

In particular, the transmission of force or torque can be specifically changed using the transmission device. In particular, the transmission of force or torque between the rotating components can be adjusted using the coil device and its magnetic field in the gap (also called the effective gap). In particular, this also results in a change in the resistance to movement (braking effect) for the rotation of the rotating components. The transmission device can be used as a coupling device or as a braking device. The rotating components then serve in particular as clutch components or as brake components and can be referred to as such. The torque can also be referred to as braking torque or clutch torque.

The device can be designed as a steering input device for inputting a steering movement according to the steer-by-wire concept or as an operating device for setting operating states by means of rotary movements and/or linear movements (which are converted into rotary movements). The transmission device can be used as a braking device and/or in the sense of a clutch.

In the context of the present invention, a magnetically non-conductive material is understood to mean in particular a material with a permeability number of less than ten and in particular less than two and for example one or less than one. Magnetically conductive materials are understood to mean in particular materials with a permeability number of greater than ten and preferably ferromagnetic materials. The magnetic conductivity is the “relative magnetic permeability”, which is also simply called “magnetic permeability”.

Further advantages and features of the present invention will become apparent from the embodiments which are explained below with reference to the accompanying figures.

Showing:

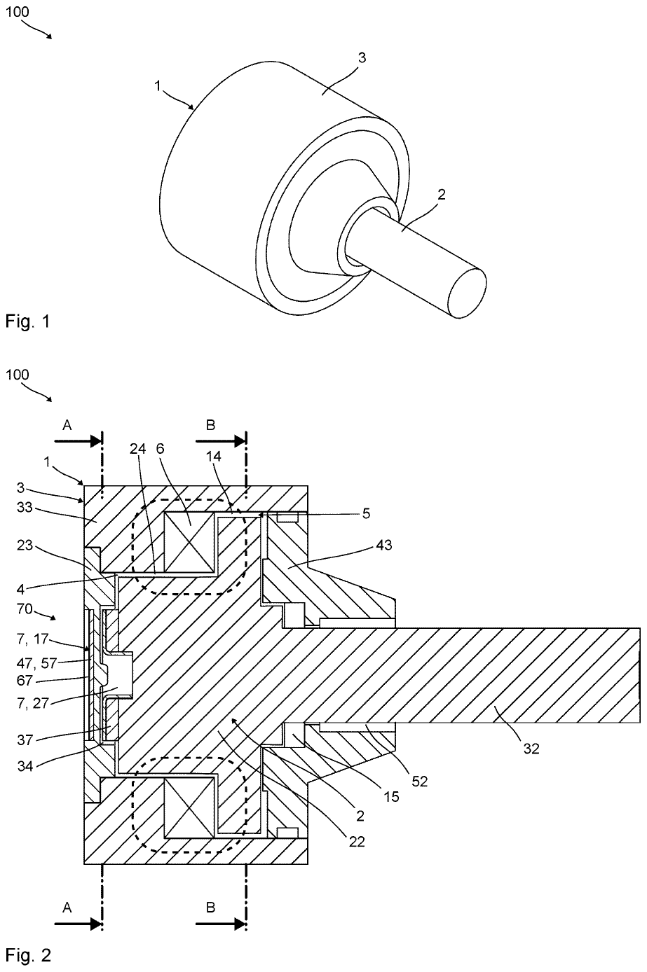

FIG. 1 is a purely schematic representation of a device according to the invention in a perspective view;

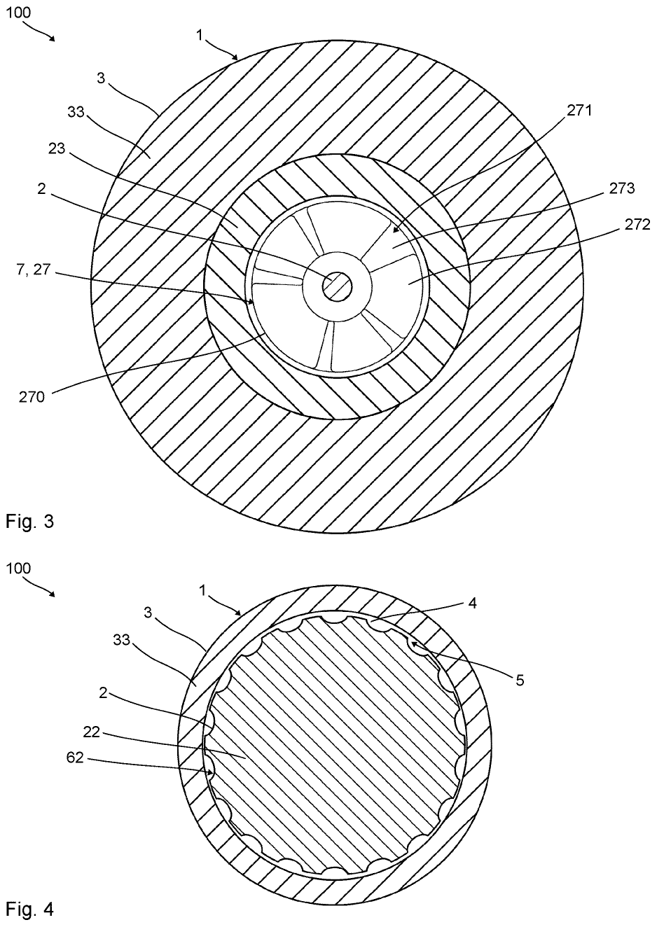

FIG. 2 shows the device of FIG. 1 in a sectioned side view;

FIG. 3 shows the device in a view along the line A-A of the FIG. 2 sectional view;

FIG. 4 shows the device in a plane taken along line B-B of FIG. 2 sectional view;

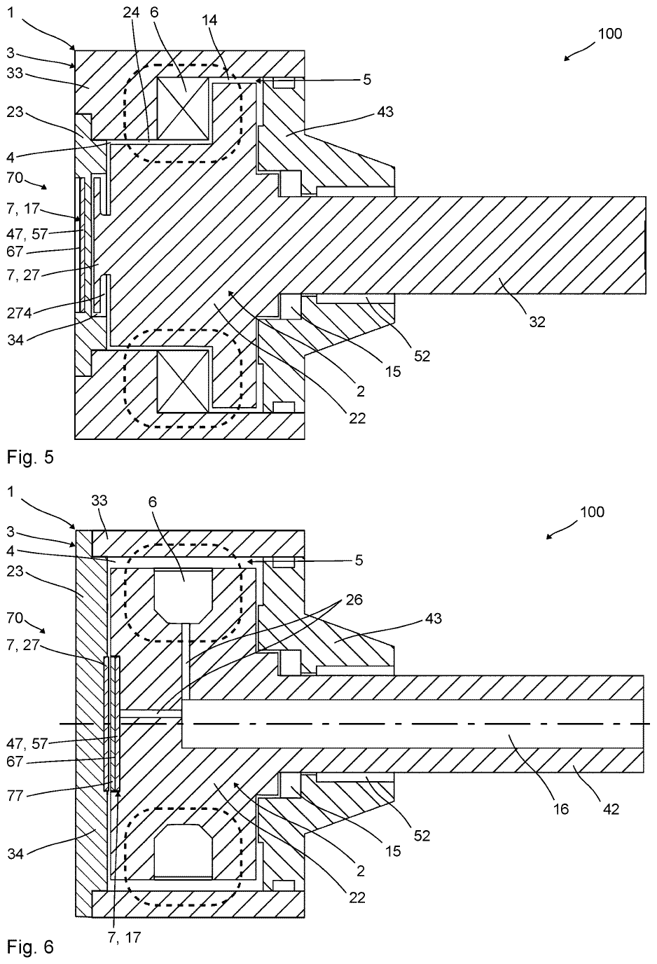

FIG. 5 is a purely schematic representation of a device according to the invention in a sectional side view;

FIG. 6 is a further purely schematic representation of a device according to the invention in a sectional side view; and

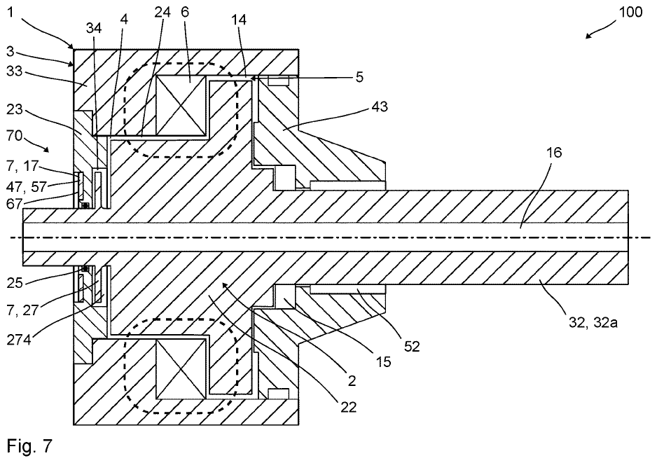

FIG. 7 is a purely schematic representation of a device according to the invention in a sectional side view.

FIG. 1 shows a device 100 according to the invention with a magnetorheological transmission device 1 with two rotary components 2, 3 and a sensor device 70 (not visible here) for detecting position information of the rotary components 2, 3. The dimensions or ratios here and in the other figures are purely schematic and in particular not drawn to scale for reasons of visibility.

The device 100 is, for example, an operating device. For this purpose, the radially outer rotary component 3 is designed, for example, as a rotary knob (or thumb roller). The rotary knob can also be coupled to the radially inner rotary component 2. The transmission device 1 generates, for example, haptic feedback while the rotary knob is rotated to set operating states.

However, the device 100 can also be designed, for example, as a steering input device based on the steer-by-wire principle. The transmission device 1 then serves, for example, as an actuator of a steering unit of a vehicle or in a steering wheel of a game controller.

FIG. 2 shows an example of an internal structure of the device 100. A gap 4 is formed between the rotary components 2, 3, in which a magnetorheological medium 5 is arranged. A seal 15 is provided to seal the gap 4 from the outside. A magnetic field is generated via a coil device 6 attached to the outer rotary component 3. The magnetic field influences the medium 5 so that the mobility of the rotary components 2, 3 is subjected to a targeted torque.

The inner rotary component 2 comprises a magnetically conductive core 22, which is here connected in one piece to a shaft 32. The shaft 32 is rotatably mounted on the radially outer rotary component 3 by means of a bearing 52. The radially outer rotary component 3 is fixed here, while the radially inner rotary component 2 is rotatable. The rotary component 3 is, for example, fastened to a support structure (not shown).

The radially outer rotary component 3 comprises a magnetically conductive ring unit 33 on which the coil device 6 is accommodated. The ring unit 33 is cylindrical and stepped on its radial inner side so that the core 22 can be rotatably accommodated therein. A front plate 43 is attached to one axial end face of the ring unit 33 and a cover unit 23 is attached to the other axial end face.

The core 22 and the ring unit 33 are stepped here, so that two gap sections 14, 24 with different diameters are formed for the gap 4. When the coil device 6 is active, its magnetic field runs through the core 22 and the ring unit 33 as well as through the gap 4 and the medium 5 located therein, so that a closed magnetic circuit is formed (shown here in dashed lines).

The core 22 is provided with a circumferential contour. This results in a different gap height in the circumferential direction, which can be clearly seen in FIG. 4. In the example shown here, the core 22 is provided with a star contour 62 equipped. The star contour 62 has a sequence of elevations and depressions around its circumference. The elevations projecting into the gap 4 can be referred to as magnetic field concentrators. The magnetic field generated by the coil device 6 preferably runs over those areas of the gap 4 that have a smaller gap width (thus the magnetic field runs in the area of the magnetic field concentrators). This means that particularly high torques or braking torques can be provided despite the compact dimensions.

The sensor device 70 is shown in more detail in FIGS. 2 and 3 and is equipped as an inductive rotary encoder with two sensor units 7. One sensor unit 7 is an active exciter-receiver unit 17 with an exciter coil 47 and a receiver coil 57. The exciter coil 47 and the receiver coil 57 are arranged in one plane and fastened to a circuit board 67 and, for example, a circuit board. The exciter-receiver unit 17 is arranged here on an axial end face of the cover unit 23 facing away from the gap 4.

The other sensor unit 7 is a passive target unit 27 with a conductive rotor geometry 270. As can be clearly seen in FIG. 3, the rotor geometry 270 has a relief structure 271 with elevations 272 and depressions 273. The rotor geometry 270 is designed purely as a wing-like structure, whereby the elevations 272 correspond to the wings, so to speak. The elevations 272 are designed asymmetrically or distributed asymmetrically. As a result, the rotor geometry 270 can encode absolute position information.

During operation of the sensor device 70, eddy currents are induced in the target unit 27 by the excitation coil 47. The excitation coil 47 is, for example, subjected to a frequency of between 2 and 5 MHz. The eddy currents of the target unit 27 in turn cause a magnetic field in the receiver coil 57, whereby the receiver coil 57 delivers a current waveform or a voltage waveform. The position information and, for example, the angular position of the target unit 27 are determined from these signals. The shape of the signal is determined by the rotor geometry 270. In the example shown here, the sensor units 7 are spaced apart from one another by a few millimeters to less than 1 mm.

The invention presented here offers a particularly compact integrated sensor device 70, which at the same time enables very precise and reproducible detection of position information. For this purpose, the target unit 27 is attached to the core 22 in a rotationally fixed manner. The target unit 27 is located on an axial end face of the core 22. The target unit 27 protrudes with its rotor geometry into the gap 4. In the area of the target unit 27, the gap 4 runs in a radial direction with respect to its main plane or transversely to the axis of rotation of the rotating components. In other words, in the area of the sensor units 7 there is a radially running gap section 34. In the gap section 34, the gap 4 is thus delimited by the target unit 27 in the sense of a wall. On the opposite side, the gap 4 is delimited by the cover unit 23.

For inductive rotary encoders, it is generally known that electrically conductive materials in the immediate vicinity of the target unit 27 or materials conductively connected to the rotor can significantly distort the detected signals. Electrically conductive materials between the excitation-receiver unit 17 and the target unit 27 are considered particularly critical.

Surprisingly, tests have shown that the medium 5, which is magnetically very conductive (but electrically rather poorly conductive), does not have a negative effect on the function of the sensor device 70 when it is located in the gap 4 between the sensor units 7. This finding is in clear contrast to the expectation that the medium 5 measurements would be severely distorted or even made impossible.

As a result, the gap 4 can be filled with the medium 5 in such a way that the medium 5 is also located between the sensor units 7. As a result, the eddy currents or fields that interact between the sensor units 7 must pass through the gap 4 and the magnetorheological medium 5 located therein. A seal, which would undesirably increase the base torque due to friction between the rotating components 2, 3, can therefore be dispensed with. This further improves the integration of the sensor units 7 without having to accept any loss in sensor quality.

In order to decouple the rotor geometry 270 from the core 22 with respect to the induced eddy currents, a shielding component 37 is provided here. This consists of an electrically and/or magnetically non-conductive material and runs between the rotor geometry 270 and the core 22.

The cover unit 23 is made of a material that is permeable to the fields or eddy currents, such as plastic. As a result, the arrangement of the exciter-receiver unit 17 on an outside of the cover unit 23 facing away from the target unit 27 does not lead to any signal interference.

The sensor device 70 can be equipped here with a correction device which can carry out a compensation process and, for example, compensate for an off-axis deviation and/or a tilt deviation.

FIG. 5 shows an embodiment of the previously described device 100, in which the target unit 27 is connected in one piece (materially integral) to the radially inner rotary component 2. For this purpose, the rotor geometry 270 was incorporated directly into the material of the core 22 and, for example, milled.

To prevent the induced eddy currents from spreading into the core 22 In order to counteract this, the rotor geometry 270 is equipped with a circumferential separation joint 274. The medium 5 is also located in the separation joint 274. Alternatively or additionally, air or a shielding material can be arranged in the separation joint 274.

FIG. 6 shows an embodiment of the device 100 in which the radially inner rotary component 2 is designed to be stationary. For this purpose, the inner rotary component 2 here has an axis 42 which is, for example, connected in one piece to the core 22. The axis 42 is fastened to a suitable support structure. The radially outer rotary component 3 is rotatably mounted on the axis 42 via the bearing 52.

The electrical coil device 6 and the exciter-receiver unit 17 are arranged here on the inner rotary component 2. The axis 42 is equipped with a supply channel 16 for its supply lines. The supply channel 16 has channel arms 26 which extend through the core 22 to the coil device 6 or to the exciter-receiver unit 17.

The exciter-receiver unit 17 is embedded in the core 22 on an axial end face. The exciter coil 47 and the receiver coil 57 as well as the circuit board 67 are covered with a cover 77 opposite the gap 4. The cover 77 consists, for example, of plastic or of another material suitable with regard to the electromagnetic interactions. This means that additional shielding between the rotor geometry 270 and the cover unit 23 can be dispensed with.

The target unit 27 is arranged here on the cover unit 23 of the radially outer rotary component 3. For example, the target unit 27 with its rotor geometry 270 consists of a metallic material, while the cover unit 23 is made of a plastic. In the embodiment shown here, the target unit 27 with its rotor geometry 270 is located directly in the gap 4 and has contact with the medium 5 located therein. The electromagnetic interactions between the sensor units 7 must pass through the cover 77 and the gap 4 as well as the medium 5 located therein.

FIG. 7 shows a variant of the device 100 described with reference to FIG. 5, in which the inner rotary component 2 penetrates the outer rotary component 3 on both axial sides. A penetration is designed here as a through hole in the cover unit 23.

An O-ring or another suitable type of shaft seal 25 is arranged between the shaft 32 and the cover unit 23. The shaft 32 is designed here as a hollow shaft 32a. The exciter-receiver unit 17 is designed here as a circular ring and has a central bore through which the shaft 32 extends. The target unit 27 is designed here as one piece with the shaft 32. However, it is also possible that the target unit 27 is a separate component (as shown, for example, in FIG. 2 or 6).

This variant can be arranged particularly advantageously in the axial direction between two components, such as a steering input device and a motor of a force feedback actuator. By providing the sensor device 70 in the device 100, an additional sensor device at another location in such an arrangement can preferably be dispensed with.

List of reference symbols:

| | |
|---|---|
| 1 | Transmission device |
| 2 | Rotary component |
| 3 | Rotary component |
| 4 | Gap |
| 5 | Medium |
| 6 | Coil device |
| 7 | Sensor |
| 14 | Gap section |
| 15 | Seal |
| 16 | Supply channel |
| 17 | Exciter-receiver unit |
| 22 | Core |
| 23 | Cover unit |
| 24 | Gap section |
| 25 | Shaft seal |
| 26 | Channel arm |
| 27 | Target unit |
| 32 | Shaft |
| 32a | Hollow shaft |
| 33 | Ring unit |
| 34 | Gap section |
| 37 | Shielding component |
| 42 | Axis |
| 43 | End plate |
| 47 | Exciter coil |
| 52 | Bearing |
| 57 | Receiver coil |
| 62 | Star contour |
| 67 | Circuit board |
| 70 | Sensor |
| 77 | Cover |
| 100 | Device |
| 270 | Rotor geometry |
| 271 | Relief structure |
| 272 | Elevations |
| 273 | Depression |
| 274 | Separation joint |

1-23. (canceled)

24. A device, comprising:
at least one magnetorheological transmission device having at least two rotary components movable relative to each another;
at least one sensor for detecting position information of at least one of said at least two rotary components;
said sensor having two sensor units, one sensor unit of said two sensor units being an active excitation-receiver unit and the other sensor unit of said two sensor units being a passive target unit;
one sensor unit of said two sensor units being arranged on one rotary component of said at least two rotary components and the other sensor unit of said two sensor units being arranged on the other rotary component of said at least two rotary components; and
at least one circumferential gap being formed between said at least two rotary components, a magnetorheological medium being arranged in said gap, at least one electrical coil for generating a controllable magnetic field in said gap, and said gap being at least partially formed between said two sensor units.

25. The device according to claim 24, wherein at least one of said two sensor units is at least partially arranged in said gap.

26. The device according to claim 24, wherein said medium is arranged at least partially between said two sensor units, such that electric or magnetic fields emanating from said two sensor units must pass through said medium.

27. The device according to claim 24, wherein at least one of said two sensor units is at least partially surrounded by said medium.

28. The device according to claim 24, wherein at least one sensor unit of said two sensor units is rotationally fixedly connected to the rotary component on which said at least one sensor unit is arranged.

29. The device according to claim 24, wherein said two sensor units are each arranged on an axial end face of the respective rotary component of said at least two rotary component on which said sensor unit is arranged.

30. The device according to claim 24, wherein at least one of said two sensor units is arranged on a component structure of the respective rotary component on which said sensor unit is arranged that directly delimits said gap.

31. The device according to claim 30, wherein at least one sensor unit of said two sensor units is arranged on said component structure of the respective rotary component on which said at least one sensor unit is arranged, said component structure is magnetically and/or electrically conductive and through which the controllable magnetic field of said coil flows when said medium is influenced by said coil.

32. The device according to claim 24, wherein at least one sensor unit of said two sensor units is at least partially integrally connected to the respective rotary component on which said at least one sensor unit is arranged.

33. The device according to claim 24, wherein:
said at least two rotary components are arranged coaxially to one another at least in sections;
a radially outer rotary component of said at least two rotary components has a cover which axially covers a radially inner rotary component at an end face of said radially inner rotary component; and
one sensor unit of said two sensor units is arranged at least partially on said cover.

34. The device according to claim 24, wherein:
said at least two rotary components are arranged at least partially coaxially to one another;
a radially inner rotary component of said at least two rotary components has a magnetically and/or electrically conductive core; and
one sensor unit of said two sensor units is arranged on said core.

35. The device according to claim 24, wherein said target unit has at least one rotor geometry, and said rotor geometry encodes relative and/or absolute position information.

36. The device according to claim 35, wherein said rotor geometry is arranged in said gap and is covered by said medium.

37. The device according to claim 35, wherein said rotor geometry has at least one relief structure with elevations and depressions distributed in a defined pattern in a circumferential direction, and said depressions are filled with said medium or with air.

38. The device according to claim 33, wherein said target unit has at least one rotor geometry, one rotary component of said at least two rotary components has a magnetically and/or electrically conductive core, and said rotor geometry is integrally connected to said core or said cover.

39. The device according to claim 35, wherein said rotor geometry has characteristics of having been produced by removing material from one of said at least two rotary components.

40. The device according to claim 34, wherein said target unit has at least one rotor geometry, said rotor geometry has at least one separation joint on an axial side facing said core in order to counteract a propagation of induced eddy currents into said core.

41. The device according to claim 24, wherein:
said target unit has at least one rotor geometry, one rotary component of said at least two rotary components has a magnetically and/or electrically conductive core, and another rotary component of said at least two rotary components has a cover;
said target unit is attached as a separate component to said core or to said cover; and
a magnetically and/or electrically non-conductive shielding component is arranged between said rotor geometry and said core or between said rotor geometry and said cover.

42. The device according to claim 24, wherein:
said target unit has at least one rotor geometry and one rotary component of said at least two rotary components has a cover; and
said rotor geometry is arranged on an inner side of said cover facing said gap or on an outer side of said cover facing away from said gap.

43. The device according to claim 24, wherein said electric coil is arranged on one rotary component of said at least two rotary components, and said exciter-receiver unit is arranged on the same said one rotary component of said at least two rotary component.

44. The device according to claim 24, wherein:
said exciter-receiver unit has an exciter coil and a receiver coil;
said exciter coil is configured to induce eddy currents in said target unit; and
said eddy currents induced in said target unit are configured to induce a field in said receiver coil, and said field is dependent on a rotational position of said target unit relative to said exciter-receiver unit.

45. The device according to claim 44, wherein said excitation coil and said receiver coil lie at least partially in a common plane.

46. The device according to claim 24, wherein said magnetorheological medium is formed as a powder.
